(19) United States
(12) Patent Application Publication
(10) Pub. No.: US 2013/0232522 A1
(43) Pub. Date: Sep. 5, 2013

(54) SYSTEMS AND METHODS FOR REAL-TIME UNIFIED MEDIA PREVIEW

(71) Applicants: Shemimon Manalikudy Anthru, Dayton, NJ (US); Jens Cahnbley, Princeton Junction, NJ (US); David Anthony Campana, Kirkland, WA (US); David Brian Anderson, Hamilton, NJ (US); Ishan Uday Mandrekar, Monmouth Junction, NJ (US)

(72) Inventors: Shemimon Manalikudy Anthru, Dayton, NJ (US); Jens Cahnbley, Princeton Junction, NJ (US); David Anthony Campana, Kirkland, WA (US); David Brian Anderson, Hamilton, NJ (US); Ishan Uday Mandrekar, Monmouth Junction, NJ (US)

(73) Assignee: THOMSON LICENSING, Issy de Moulineaux (FR)

(21) Appl. No.: 13/884,306

(22) PCT Filed: Nov. 16, 2010
(86) PCT No.: PCT/US10/02991

§ 371 Date: May 9, 2013

(51) Int. Cl. H04N 21/442

(52) U.S. Cl. CPC H04N 21/44204
USPC 725/20; 725/14

(57) ABSTRACT

A centralized media device accesses media sources via a networked system to display a unified preview of media contents stored on different devices. The unified previews are provided in real-time, pushing previews to multiple user devices. The centralized media device can employ user profile information to tailor the unified previews to individuals. It can also employ external sources to obtain relevant content images and information to provide to a user. The centralized media device can operate independently of the type of media, media source and/or viewing devices.

### BACKGROUND

Oftentimes when watching television, a viewer will “channel surf” to see what is on the other available channels. This can be cumbersome so televisions were developed that could display multiple channels at one time in a mosaic pattern, allowing the user to watch more than one channel on a given screen. This was accomplished by using multiple tuners, where a first tuner was used for accessing programming that is being watched, and a second tuner which would provide screenshots of various channels, where the previews could be cycled between various channels. Thus, creating mosaic with a main picture (from the first tuner) and a bunch of smaller pictures (from the second tuner) surrounding the main picture. These smaller pictures were updated with the second tuner, while the first tuner provided the television picture for the main picture. However, the main issue with this approach is that is limited to a specific device having multiple tuning capabilities.

Another approach that can be used for previewing media was the use of a device such as a screen saver which periodically shows different pictures of picture files stored on a storage device. For example, at time X, a first JPEG picture is shown. At a second time Y, a second JPEG is shown, until all picture files stored are displayed. The problem with this approach is that the type of media being shown, picture files, is the only type of media that can be displayed.

### SUMMARY

A unified preview of media contents stored on different devices provides real-time, pushing previews to multiple user devices. This allows content access to a person despite the content being difficult to sort out and retrieve. Different types of media are utilized to form a unified preview mode where aspects of the different media are made available in the mode. The unified preview mode interoperates with different sources of media (e.g., television, Internet, storage devices) and with different devices to create a unified preview mode.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a block diagram of a unified preview system in accordance with an aspect of an embodiment.

FIG. 2 is a flow diagram of a method of unifying previews in accordance with an aspect of an embodiment.

FIG. 3 is another flow diagram of a method of unifying previews in accordance with an aspect of an embodiment.

FIG. 4 is yet another flow diagram of a method of unifying previews in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

Each day vast amounts of media are created. More and more devices are developed to provide this media. Cameras, cell phones, video records, etc. generate media that users attempt to consume. An average user stores their media on a variety of devices such as, for example, computers, cds, dvds, servers, and other devices. There is no one common thread that links all of these different types of media. Users must sort through all of their devices to retrieve a desired piece of media. Unified media preview changes this environment by allowing a user to not only access their media, but to also have their media previews “pushed” to them. That is, suggestions or previews are given to a user based on their profile and/or current viewing habits. This permits users to more fully appreciate and enjoy their own media.

The term “media” is any type of audio, video, and/or audio and video media. Examples of such media include, but are not limited to, music files, television shows, movies, digital pictures, electronic books, and the like. The term media also encompasses how such files are encoded. For example, a television show can be encoded in a variety of formats and profiles (see e.g., MPEG-2 video or MPEG-4, Part 4 video, MPEG-4, Part 10 video, Flash, etc.). It can also use different audio formats (e.g., AC-3, MP3, Vorbis, FLAC, etc.). Considering these formats, such media files can be encoded using a lossless (FLAC) or lossy (MP3) type of compression. Media files can also be represented without any compression, as well. Consideration is given as to what media is available and how to obtain it. Generally speaking, there are three types of sources of media that are brought together.

The first source of media is the type of media that is stored on a user's device, such as, for example, a computer, a personal video recorder (PVR), a gateway, a memory stick, and the like, where a user typically uses a media program like Windows Media 9, Real Player, Flash, etc., or the device itself is used to access and playback the specific media. For example, a user can play back a recorded television show using a PVR using an interface such as Replay TV or TIVO. This media is identified as “stored media.”

A user has the ability to access not just one device, but a plurality of devices that are networked together through an interface such as, for example, Ethernet or 802.11 based wireless interfaces and the like. The discovery of the different media residing in multiple devices is accomplished by using, for example, technologies like UPnP (Universal Plug and Play). UPnP enabled devices can advertise a list of media content available to a home gateway server once the devices are connected to a network. The gateway can then index the media contents stored on multiple devices.

A second type of media being accessed is through the real-time playback of a media source. An example of this source of media is the use of a device, such as a television tuner, which accesses programming being received from a real-time broadcast using a transmission technology such as ATSC/Cable/Satellite/IPTV/Streaming Audio, and the like. The consideration for this type of media being accessed is that a user is specifically “tuning” to such media. Going back to the previous example, one can consider the situation where a person is watching a television show using a set top box or television receiver. The user can switch through different channels of programming by using a device such as a remote control, where the channels are changed in response to a “channel change” command. The television receiver then changes channels in response to such a command to access a new channel. The contents of the new channel are then played back (as audio and video). These are examples of media known as “real time media.”

A third type of media available to a user is media that is suggested to a user. That is, this type of media is not currently being accessed by a user, but is suggested to the user for access. Various approaches for implementing this type of media include, for example, starting with a user profile generated by the user themselves by entering in a few keywords, or having such a profile generated in response to a user's viewing and listening habits. A user profile based recommendation engine can be used for suggesting content. For example, a learning algorithm can monitor the time and user's viewing and listening habits based on time. The recommendation engine can also automatically create recordings of TV episodes and provide a catch-up TV list for the user.

In response to the user's profile, a series of media selections are offered for playback to the user. For example, if a user likes watching sports, the media such as baseball programs or football games are suggested to the user for selection. In the example of a television receiver, a football game that is suggested to a user can be a television show that is either on at the time the football game is selected, or will be on in the next few hours. Likewise, programming can also be suggested for recording in a similar manner using the profile that is developed for a user. These types of media are known as “suggested media.”

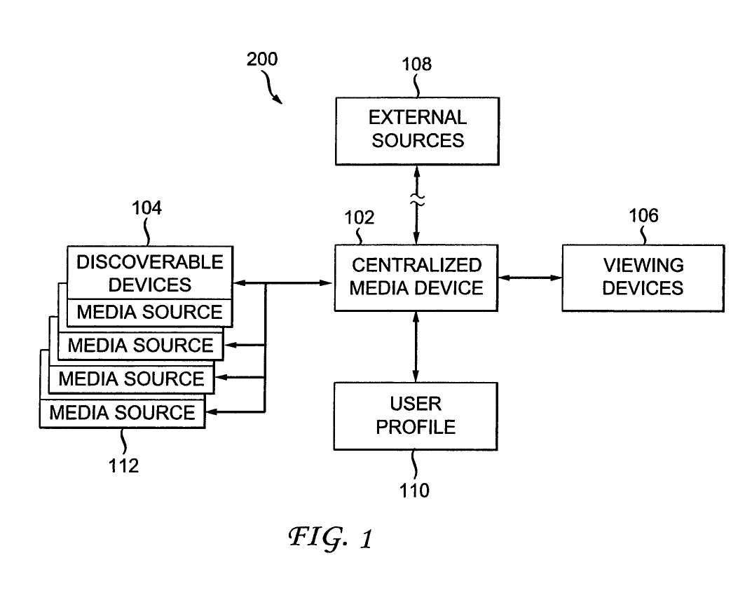

FIG. 1 shows an example system 100 that utilizes a centralized media device 102 that interfaces with discoverable devices 104 and interfaces, not only with the discoverable devices 104, but also with other viewing devices 106. The centralized media device 102 can be an intelligent gateway and/or a media server and the like. It 102 communicates with discoverable devices 104 to retrieve media from media sources 112 associated with the discoverable devices 104. The centralized media device 102 can act based upon information retrieved from viewing devices 106 and/or from optional user profile 110. The user profile 110 can contain viewing habits, preview delay settings, update rates, etc. for a given user and/or for a given class of users (e.g., those who watch football, a particular family, a particular viewing device, particular type of presentation, etc.). The viewing devices 106 can include, for example, the discoverable devices 104. The viewing devices 106 can also include multiple screens—for example, one for viewing real-time and one for viewing supplied previews and the like. They are not meant to be mutually exclusive.

When the centralized media device 102 operates in “push” preview mode, it provides previews that are relevant to content being viewed. Thus, the centralized media device samples content viewed on the viewing devices 106 and selects pertinent scene samples to show as previews for a user. It is possible that scene selections are not available within the centralized media device's local area. When this occurs, the centralized media device 102 can utilize optional external sources 108 to locate preview material. The external sources 108 can include, but is not limited to, other media sources obtainable via networks and the Internet and the like. The centralized media device 102 operates independently of the type of media, the type of device storing the media and the viewing devices. It 102 can retrieve information from a multitude of storage devices and can retrieve photos, movies, television shows, etc. It can then show previews on computer screens, televisions, cell phones, etc., formatting media previews as required.

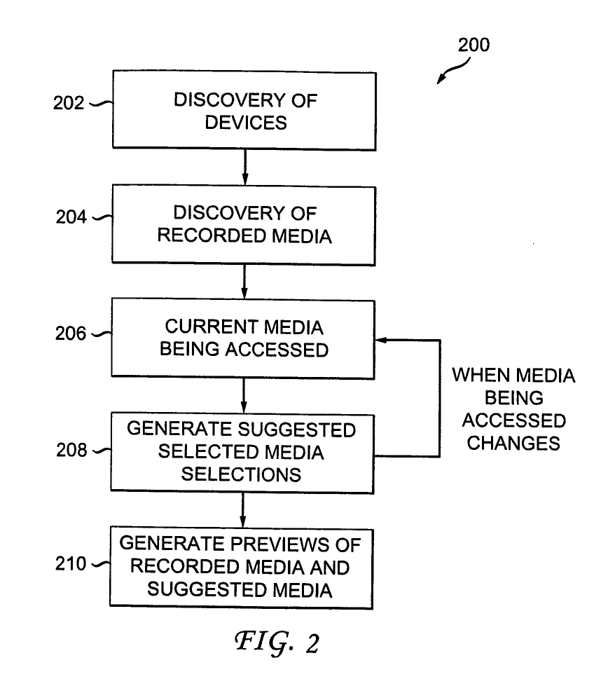

In view of the exemplary systems shown and described above, methodologies that can be implemented in accordance with the embodiments will be better appreciated with reference to the flow chart of FIGS. 2-4. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 2 shows a method 200 where there is a hierarchy of discovery between different devices and media sources. The first block 202 represents various discovery algorithms that are used to discover which devices can be accessed by a centralized media device such as, for example, an intelligent gateway or media server. The second block 204 which addresses the discovery of recorded media determines what media already exists for the devices that are discovered in the first block. For example, video media files stored in a PVR that is on a network can be located and identified. Similarly, the video/music media files that exist on a media server can also be identified. All of the identified files are merged into a common list using techniques such as, for example, extensible markup language (XML) translations, and the like. The third block 206 identifies the media being accessed, while the fourth block 208 identifies media that can be interesting to a user based upon the media that they are currently accessing. Block five 210 presents the various options of generating those previews.

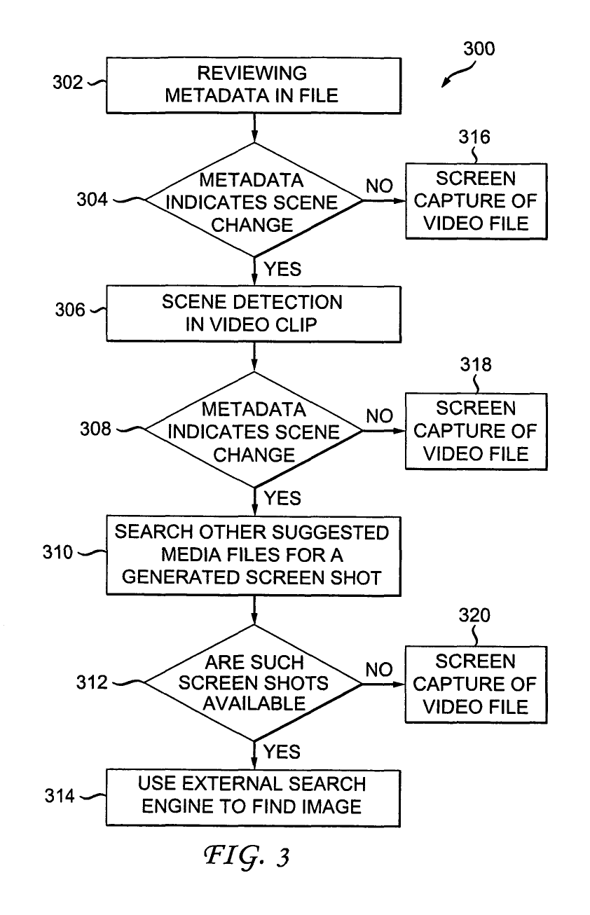

One embodiment 300 illustrated in FIG. 3 makes use of screen shots. The display of screenshots can be performed, for example, via a carousel—random display of pictures, and in other manners. Metadata for media content is reviewed 302 to determine when media content changes such as, for example, when scene changes occur 304. If no scene change is detected, a screen capture of, for example, a video file is performed 316. However, if there is an indication of a scene change, the scene change is detected in the video clip 306. If no further scene changes are indicated by the metadata, a screen capture of the video file is performed 318. If a scene change has occurred but a screen capture is not possible 308, a search is performed in other suggested media files for a generated screen shot 310. If a screen shot is found 312, a screen capture of the video file is saved 320. If not 312, an external search engine is employed to locate a suitable image 314.

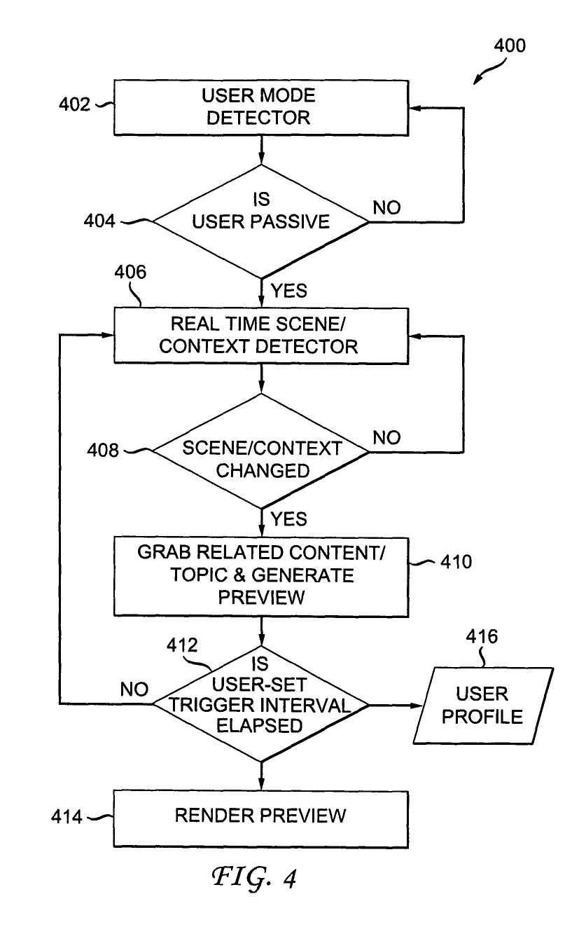

In another embodiment, a system can detect user activity on a primary screen or connected to a secondary screen. And while the user is passively watching content on primary screen the system can detect scene changes or context changes in real-time by parsing the closed caption for example. On these triggers, the related content (informational text or graphics or advertisement) can be pushed to the user in real-time. The real-time rendering of related content can be done on the primary screen or on a connected secondary screen device. FIG. 4 is an illustration 400 of how a user can also control the rate at which context change triggers related content (preview) display. A user mode is first detected 402. This determines if the user is passively watching or actively engaging a viewing device. If the user is in an active mode, the detection resumes 404. However, if the user is passively engaged 304, a real-time scene/context detection is performed 406. If the scene and/or context has not changed, the detection resumes 408. However, if a change has been detected 408, related content and/or topic material is retrieved and a preview is generated 410. A determination is then made as to whether user data from a user profile 416 indicates that a trigger interval has lapsed 412. If the interval has lapsed 412, a preview is then rendered 414.

It should be noted that instances herein can also include information sent between entities. For example, in one instance, a data packet, transmitted between two or more devices, that facilitates content/services distribution is comprised of, at least in part, information relating to content/service distribution receiver software relayed to content/service distribution receivers via a multicast message.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A content preview generation system, comprising:
a centralized media device that monitors at least one viewing device for media content, determines which scene is being viewed, accesses at least one media source and provides at least one preview related to the media content to at least one viewing device.

2. The system of claim 1, wherein the centralized media device utilizes at least one user profile to determine at least one preview to provide for the at least one viewing device.

3. The system of claim 1, wherein the centralized media device utilizes captioning meta data to determine which scene is being viewed.

4. The system of claim 1, wherein the centralized media device accesses at least one remote media source to obtain preview information.

5. The system of claim 1, wherein the centralized media device is at least one of a gateway and a media server.

6. The system of claim 1, wherein the centralized media device provides at least on preview for at least one of a photograph, a video, a television show and an audio recording.

7. The system of claim 1, wherein the centralized media device provides at least one preview to a viewing device other than the viewing device that a user is currently viewing.

8. The system of claim 1, wherein the centralized media utilizes a localized network to discover at least one media source.

9. A method for generating previews, comprising the steps of:
monitoring at least one viewing device for media content;
determining which scene is being viewed;
accessing at least one media source to retrieve content related to the scene; and
generating at least one preview for media content associated with the retrieved content.

10. The method of claim 9, further comprising the step of:
displaying the generated preview on at least one viewing device.

11. The method of claim 9, further comprising the step of:
accessing at least one media source from a remote location.

12. The method of claim 9, further comprising the step of:
generating at least one preview based on at least one of a user profile and genre of media content being viewed.

13. The method of claim 9, further comprising the step of:
generating previews from a centralized location independent of media sources utilized to generate the previews..

14. The method of claim 9, further comprising the step of:
displaying at least one generated preview on a viewing device other than a viewing device displaying the media content on which the preview is based.

15. A system that generates previews, comprising:
means for monitoring at least one viewing device for media content;
means for determining which scene is being viewed;
means for accessing at least one media source to retrieve content related to the scene; and
means for generating at least one preview for media content associated with the retrieved content.
